(19) United States
(12) Patent Application Publication
(10) Pub. No.: US 2025/0029169 A1
(43) Pub. Date: Jan. 23, 2025

(54) SYSTEM AND METHOD FOR FACILITATING BUYING AND SELLING OF BLOCKCHAIN PROTECTED ITEMS

(71) Applicant: AN AUTHENTIC LLC, Los Angeles, CA (US)

(72) Inventor: Samuel Klein, Los Angeles, CA (US)

(21) Appl. No.: 18/581,912

(22) Filed: Feb. 20, 2024

Related U.S. Application Data
(60) Provisional application No. 63/446,446, filed on Feb. 17, 2023.

(51) Int. Cl. G06Q 30/0601; G06K 7/10; G06K 7/14; G06Q 20/12; G06Q 20/36; G06Q 20/38; G06Q 20/40; G06Q 20/42

(52) U.S. Cl. CPC G06Q 30/0635; G06K 7/10297; G06K 7/1413; G06K 7/1417; G06Q 20/1235; G06Q 20/36; G06Q 20/389; G06Q 20/4014; G06Q 20/42; G06Q 30/0643

(57) ABSTRACT

The present invention generally relates to systems, methods, and machine-readable media for facilitating online purchasing. Specifically, techniques are disclosed to facilitate online and mobile purchasing of items, such as apparel or other products. The system and method allow users and retail brands to set up an account in a LNK app. The user is then able to scan items using a computing device and add the scanned item to a digital closet. Transfer of the item is initiated when the item is scanned, and ownership transfer occurs when the item is added to the user's closet.

### RELATED APPLICATIONS

This application claims the benefit of U.S. Provisional Patent Application No. 63/446,446 filed Feb. 17, 2023, which is hereby incorporated by reference in its entirety.

### FIELD OF THE INVENTION

The present invention generally relates to systems, methods, and machine-readable media for facilitating online purchasing. Specifically, techniques are disclosed to facilitate online and mobile purchasing of items, such as apparel or other products.

### SUMMARY OF THE INVENTION

The buying and selling of clothing and other consumer goods have traditionally been fragmented processes, often lacking transparency and accountability regarding the origin and history of the products. As consumers increasingly prioritize sustainability, ethical sourcing, and authenticity, there is a growing demand for solutions that provide verifiable provenance and traceability throughout the lifecycle of goods.

Existing methods for tracking products typically rely on manual record-keeping systems, such as serial numbers or barcodes, which are susceptible to errors, tampering, and fraud. Moreover, once a product leaves the primary market and enters secondary markets, such as resale platforms or thrift stores, the trail of its provenance often becomes obscure, making it challenging for consumers to ascertain the authenticity and history of the item.

Furthermore, the lack of standardized mechanisms for recording and verifying product transactions exacerbates the problem of counterfeit goods flooding the market, leading to economic losses for both consumers and legitimate manufacturers.

In response to these challenges, blockchain technology has emerged as a promising solution for establishing transparent and immutable records of transactions. By recording each transaction as a block in a decentralized and tamper-proof ledger, blockchain enables participants to track the entire lifecycle of a product, from its creation to its current ownership status.

Despite the potential benefits of blockchain in enhancing supply chain transparency and combating counterfeiting, its adoption in the consumer goods industry has been limited, particularly in the context of tracking individual items such as clothing.

Additionally, while software applications exist for managing inventory and tracking sales, they often lack integration with hardware-based tracking mechanisms such as QR codes, NFC (Near Field Communication) chips, RFID (Radio Frequency Identification) tags or other physical or electronic tracking means. These hardware solutions offer unique advantages in terms of scalability, ease of use, and compatibility with existing infrastructure, yet their potential remains largely untapped in the context of product tracking and provenance verification.

The present invention addresses these shortcomings by providing a comprehensive solution that combines hardware-based tracking mechanisms with blockchain (or other distributed ledger technologies (DLTs), collectively referred to herein as blockchain technologies) technology and software applications to enable real-time monitoring and verification of product transactions. By leveraging QR codes, NFC chips, RFID tags or other physical or electronic tracking means embedded in clothing and other goods, the invention facilitates seamless data capture and transmission, ensuring accurate and transparent recording of transactions on the blockchain.

Additionally, the linking of physical goods to blockchain references allow for the provision of digital assets that are related to the physical good. No system currently provides a means for providing and tracking the ownership of a physical good via blockchain technology and associating that ownership with the ownership of a corresponding digital asset.β

Through the integration of hardware, software, and blockchain, the invention offers a scalable and interoperable solution for tracking the provenance of goods across both primary and secondary markets. By empowering consumers to make informed purchasing decisions based on verifiable data, the invention enhances trust and accountability in the global marketplace.

### SUMMARY OF THE INVENTION

According to an embodiment of the present invention, a computer implemented method for facilitating online purchases is disclosed. The method comprises the steps of: receiving an item request, wherein the item request comprises one or more of: a unique identifier, an item description, an item status, digital assets associated with the item, digital wallet information, previous transaction information, registration information, and brand information; processing a request contained in the item request, wherein the request may be selected from the group comprising: adding a new item to a registry, retrieving information from the registry related to the item, providing information to a user related to the item; and returning to the user a confirmation related to the request.

According to an embodiment of the present invention, the computer implemented method of claim 1, wherein the unique identifier is selected from the group comprising: a QR code, a unique RFID, a unique NFC, a serial code, and a bar code.

According to an embodiment of the present invention, the item status is selected from the group comprising: retail, secondary, and other.

According to an embodiment of the present invention, the method further comprises the steps of: confirming the type of request to be completed; confirming user has the authority to complete the request; and completing the request related to the item.

According to an embodiment of the present invention, the request involves processing a transaction on the item, where the item is not already in the registry, where the method further comprises the steps of: determining if the request is a batch item add or a single item add; parsing add item information from the item request; and adding the item to the registry.

According to an embodiment of the present invention, the method further comprises the step of providing a stored digital asset from the registry to the user.

According to an embodiment of the present invention, the method further comprises the step of providing a digital closet to the user, wherein the item is displayed in the digital closet.

According to an embodiment of the present invention, the method further comprises the steps of: transferring the ownership of the item to a second user; and registering a transaction record related to the transfer of ownership of the item to the second user on a blockchain.

According to an embodiment of the present invention, the method further comprises the step of updating the item status based at least part on the transfer of ownership of the item to the second user.

According to an embodiment of the present invention, a system for facilitating online purchases is disclosed. The system for comprises: one or more processors configured with machine operable code, configured to: receive an item request, wherein the item request comprises one or more of: a unique identifier, an item description, an item status, digital assets associated with the item, digital wallet information, previous transaction information, registration information, and brand information; process a request contained in the item request, wherein the request may be selected from the group comprising: adding a new item to a registry, retrieving information from the registry related to the item, providing information to a user related to the item; and return to the user a confirmation related to the request.

According to an embodiment of the present invention, the one or more processors configured with machine operable code are further configured to: confirm the type of request to be completed; confirm user has the authority to complete the request; and complete the request related to the item.

According to an embodiment of the present invention, the one or more processors configured with machine operable code are further configured to: determine if the request is a batch item add or a single item add; parse add item information from the item request; and add the item to the registry.

According to an embodiment of the present invention, the one or more processors configured with machine operable code are further configured to provide a stored digital asset from the registry to the user.

According to an embodiment of the present invention, the one or more processors configured with machine operable code are further configured to provide a digital closet to the user, wherein the item is displayed in the digital closet.

According to an embodiment of the present invention, the one or more processors configured with machine operable code are further configured to: transfer the ownership of the item to a second user; and register a transaction record related to the transfer of ownership of the item to the second user on a blockchain.

According to an embodiment of the present invention, the one or more processors configured with machine operable code are further configured to update the item status based at least part on the transfer of ownership of the item to the second user.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a schematic overview of a process, in accordance with an embodiment of the present invention;

FIG. 4 is a schematic overview of a process, in accordance with an embodiment of the present invention.

### DETAILED SPECIFICATION

The present invention is directed to systems, methods, and machine-readable media for facilitating online purchasing. In general, techniques are disclosed to facilitate online and mobile purchasing from physical stores, virtual stores, online sellers, and private sellers. According to one or more embodiments, facilitating purchasing may allow a person to purchase items more conveniently, more cheaply, and more easily directly from vendors or individuals.

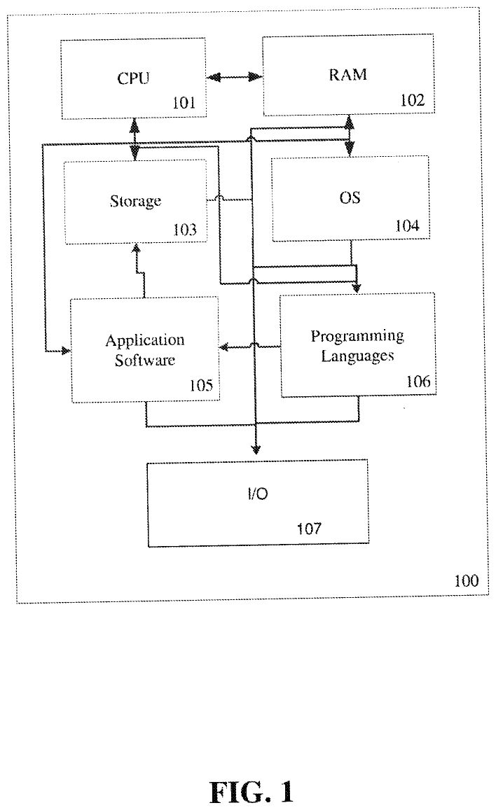

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

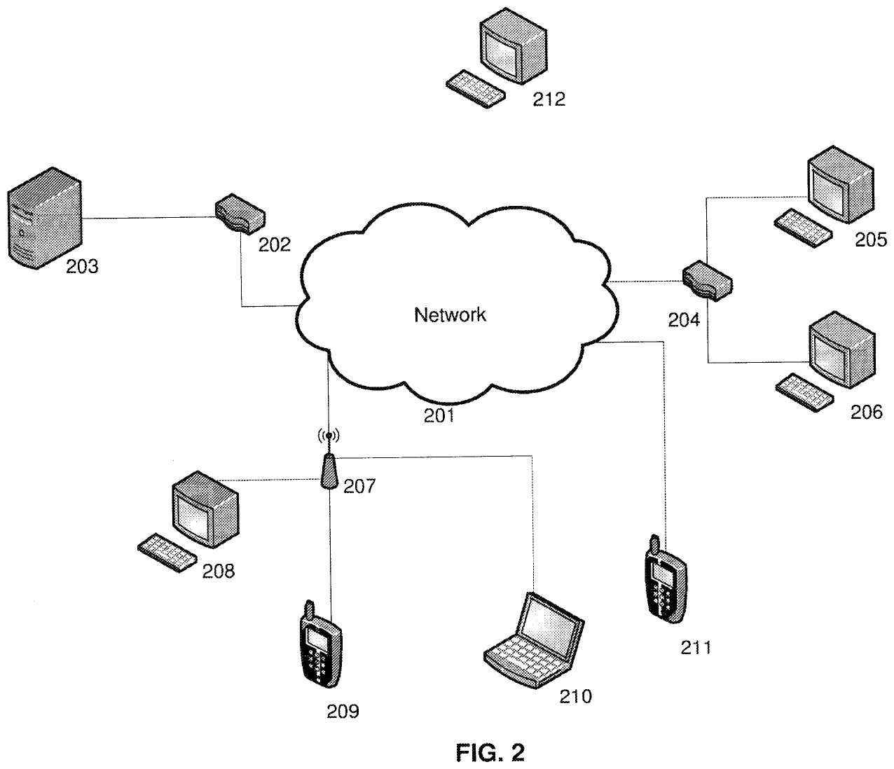

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

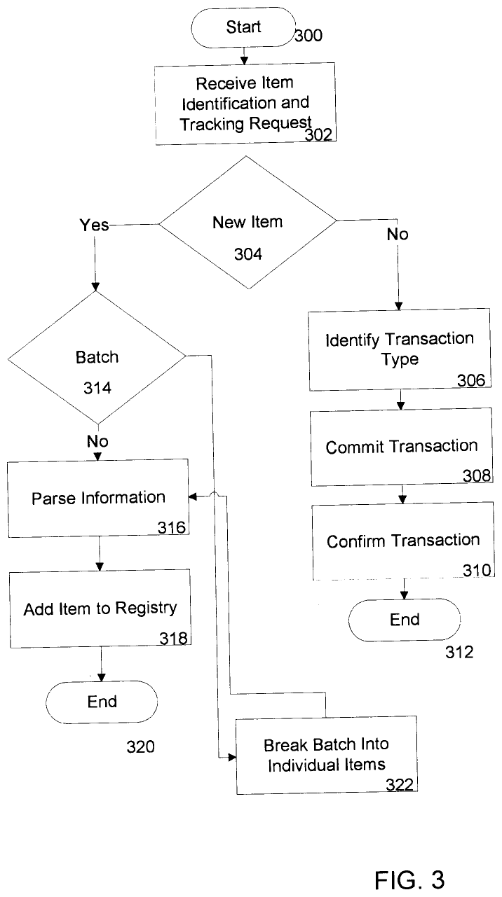

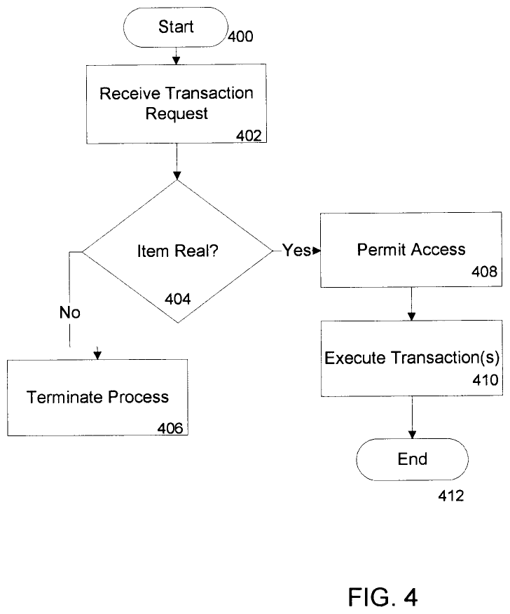

According to an embodiment of the present invention shown in FIGS. 3 and 4, an algorithm is provided that can identify an item for sale, such as a piece of apparel, based on a scanned QR (Quick Response) code, barcode, item serial number, data received from an NFC (Near Field Communication) chip, or RFID (radio frequency identification) tag, or other physical or electronic tracking means. One of ordinary skill in the art would appreciate there are numerous tracking modules that could be used to associate a particular piece of apparel to the tracking module for use with the system. For example, a user's smart phone can be used to scan a QR code displayed on or in association with an item for sale in order to quickly identify the item, including but not limited to displaying an image of the item, and providing its dimensions, colors, material properties, and other attributes, thereby expediting the purchasing experience. This facilitates the utilization of “agnostic” shopping and purchasing platforms where the user is not reliant upon vendor created webpages, ads, device applications, etc., to guide or influence purchasing decisions.

Turning now specifically to FIG. 3, a method for providing the identification of an item for sale based on a unique identifier and tracking the transaction and use of the item in one or more of a physical and electronic environment. The method starts at step 300, with the system being engaged to identify and track an item. At step 302, the system receives information related to an item to be identified and tracked. The information related to identifying and tracking the item may include, but is not limited to, a unique identifier (e.g., QR code, unique RFID, unique NFC, serial code, bar code), a description of the item to be tracked, a status of the item's transaction class (e.g., retail, secondary, other), data corresponding to a digital asset associated with the item, digital wallet information, previous transaction information, registration information, or any combination thereof.

At step 304, the system determines if the request involves a new item to add to the system, or an item already registered in the system. If the item is already registered, the system will proceed to step 306, where the system confirms the type of transaction to be completed, such as retrieve information about the status or ownership of the item, or sale/transition of the item to a new owner and change in status of the item (e.g., transition from retail status to secondary ownership status).

At step 308, the system uses the information provided and information retrieved from the system associated with the item and completes the transaction requested. At step 310, the system confirms the transaction with the requestor and the process terminates at step 312.

Returning to the decision in step 304, if the request involves adding one or more new/unregistered items, the process proceeds to step 314, where the system will then determine if the addition is a batch item add (i.e., multiple items) or a single item add. If the request is to add an individual item, the system will proceed to step 316, where the system will parse the information related to the addition of the item to the system's registry. This may include processing the data in the received request, related to the item, including, but not limited to, the type of identifier used (e.g., QR code, NFC, RFID, barcode, serial number), the type of the item, description of the item, associated brand or brand elements (e.g., logos, product name, brand name, marketing materials associated with the item), associated digital elements associated with the item (e.g., digital photos, digital descriptions, 3D elements for use in internal use cases or in third-party applications), or any combination thereof.

At step 318, once the system processes the information, the system adds the item to the system's registry, which may include submitting the item as a new item on the blockchain or other implemented distributed ledger technology. The process may occur in a manner consistent with the methodologies detailed elsewhere herein. Once added, the process terminates at step 320.

If the addition of items was a batch add, the process goes to step 322, where the system will break down the batch into individual items, and process each item via the steps detailed in steps 314-320.

Turning now to FIG. 4, a process for ensuring the purveyance of a physical asset via a digital asset backend. The process starts at step 400 with the system being engaged to check and validate the provenance of a physical item. At step 402, the system receives a request to transact on a digital asset associated with a physical asset. The request may be comprised of data associated with the assets, such that the digital asset can be identified, ownership confirmed, and if a transaction is involved, the transaction is permitted under rights related to the confirmed ownership. Request data may include, but is not limited to, item identifier, login/security data (e.g., username/password, 2FA), transaction type, or any combination thereof.

At step 404, the system processes the request information and confirms the existence and provenance of the item. If the system cannot confirm the existence of the item or if the system determines the submitting user does not have authority to access or take action on the associated digital assets, then the process will terminate at step 406.

If the item is confirmed, and the submitting user is confirmed as owner or at least someone who has the rights to access the item, at step 408, the system will provide access at the level permitted by the system as identified in its security settings with respect to the requesting user and the digital assets. At step 410, the system will allow requests from the user and process permitted transactions associated with the digital asset. Once completed, the process terminates at step 412.

Moving now to descriptions of preferred embodiments of the present invention, according to an embodiment of the present invention, a user's inventory of items can be stored in a digital wallet or subwallet which is optionally associated with a user's cryptocurrency wallet and which is used as a digital closet for a user's inventory of, for example, scanned apparel (e.g., apparel of interest identified by scanning/detecting the item's QR code or NFC chip and which may then be displayed on a user's mobile computing device). The display may contain icons, holograms, codes, menus, radio buttons, etc., that can be initiated by a mouse click or tap by the user for a touch screen display. The icons can initiate an item page or item information page. Item information is conveyed by a barcode, QR code, NFC chip, RFID tag or similar, obtained by scanning an item or tag and receiving information about the item, including, for example, an image of the item.

In certain embodiments, the system may be further configured to provide access to the scanned apparel or other items in the user's inventory a subwallet to third party applications for use in those third party applications. For instance, information about user's apparel in a subwallet may be provided to a third-party video game application for use and display on the user's avatar in that game. One of ordinary skill in the art would appreciate that there are numerous types of third party applications that the system could provide access to a user's inventory for various purposes, including numerous purposes involving virtual worlds and AR/MR/VR systems, and embodiments of the present invention are contemplated for use with any such third party applications and integration techniques utilized therewith.

In some embodiments, the subwallet is automatically generated when a user signs up for a software application (app) that facilitates buying and selling of items and is hereinafter referred to as “the LNK app.” In a preferred embodiment, the subwallet is a custodial wallet where the keys used to access inventory items are held by the LNK app. It will also be appreciated that after signing up the user can access a LNK app page screen display for display of scanned items and/or closet items.

After the user has scanned a QR code or NFC chip associated with an item the item is displayed on the user's computing device, such as a portable computing device (e.g., smart phone, tablet, AR/VR goggles or glasses, etc.) along with basic information about the item. One of ordinary skill in the art would appreciate that there are numerous types of computing devices that could be utilized for this purpose, and embodiments of the present invention are contemplated for use with any appropriate computing device. The LNK app then determines the status of the item, including: (1) whether the item is in a retail mode (i.e., the item was scanned in a retail environment); (2) whether the item is owned by another user (i.e., stored in their digital closet); or (3) whether the item is neither in retail mode nor owned by another user. If the item is owned by another user, the other user initiates a transfer of the scanned item. The item is then ready to be added to the user's digital closet and the user decides whether to add the item to his or her closet by selecting a corresponding option in the LNK app.

Once the item is added to a user's closet the item transaction is processed by, for example, transferring an amount of cryptocurrency from the user's wallet that is equal to the price of the item and transferring ownership of the item to the user. The transaction is then recorded on the blockchain. Details of the recorded transaction may include:
TO (i.e., to whom the item was transferred)
FROM (i.e., from whom the item was transferred)
DESCRIPTION OF THE ITEM; and
PRECISE GEO LOCATION OF THE ITEM.

A person of ordinary skill in the art will appreciate that physical delivery may not be necessary since the transaction may only involve a transfer of ownership of the item from one owner to another owner (e.g., the user) without actual physical delivery. Once payment is made and ownership of the item is transferred to the user, the transaction is completed.

According to an embodiment of the present invention, the LNK app is further configured to allow retail brands to sign up and generate a brand specific portal. Specifically, upon sign up, the LNK app generates a brand specific portal for the retail brand. The LNK app may be further configured to invite employees of the retail brand to join the LNK app. According to this embodiment, a user can acquire an item from the retail brand by purchasing the item anywhere the brand is sold and may initiate a process of acquiring ownership by scanning the QR code/detecting the NFC chip associated with the item. Upon purchase, ownership rights are transferred or assigned to the user with or without physical transfer of the item. More specifically, the user can scan the item in a retail mode which indicates that the item is offered for sale at a retail store. The item is then ready to be added to the user's digital closet or subwallet. The user adds the item to their subwallet (i.e., digital closet) by selecting a corresponding option in the LNK app. Once the user adds the item to their subwallet, the item transaction is initiated and transfer of the item to the user is processed. That is, ownership rights to the item are transferred to the user in the LNK app by recording the transaction in the blockchain (i.e., distributed ledger). Details of the transaction may include:
TO (i.e., to whom the item was transferred)
FROM (i.e., from whom the item was transferred)
DESCRIPTION OF THE ITEM; and
PRECISE GEO LOCATION OF THE ITEM.

The user's subwallet is updated to reflect this transfer of ownership when the transaction is recorded in the blockchain. At that point, the transaction is complete.

The LNK app is further configured to allow the brand retailer to request a batch order. The batch order request entails creating tags (QR/NFC) for each item in the batch. Once the QR/NFC tags are created, the app logs HID into the system and the batch items are ready for release.

According to a preferred embodiment, an ERC-1155 smart contract is created where ERC-1155 refers to a flexible Ethereum token standard that allows for the transfer of multiple types of tokens (e.g., fungible and non-fungible tokens) at once. The contract location is stored in the transaction database for the item and individual copies are created for each item. Subsequently, the LNK app mints an ERC-1155 token from the contract specific to the item and the token is assigned to a user's LNK wallet or subwallet. The token ID is stored in the closet item. One of ordinary skill in the art would appreciate that there are numerous types of smart contacts that could be used with embodiments of the present invention, and embodiments of the present invention are contemplated for use with any such smart contact types.

Once the QR code or NFC are created, the tags are applied to physical items. These items (i.e., the tagged batch items) are in retail mode by default and are ready to be sent to retail locations. A user can then purchase the item from the retail location as described above. In other embodiments, various types of tracking devices, such as RFID chips, NFC modules, barcodes, serial numbers, may be applied to or integrated into physical items, such as sewn into a pocket formed between two layers in a purse, or sewn into the collar or hemline of a coat, jacket or other article of clothing. One of ordinary skill in the art would appreciate that there are numerous tracking devices and ways they could be integrated or attached to these physical goods, and embodiments of the present invention are contemplated for use with any appropriate tracking device and integration/attachment method.

Wallet and LNK database security are of paramount importance. According to one embodiment, wallet security is achieved by using one wallet per user to create all contracts and tokens. Fraudulent and/or incorrect transactions are easily detected by checking and validating item information acquired via QR code or NFC. Any suspicious activity is easily identified by reviewing an account's history. In one embodiment, private keys for the wallet are stored in the LNK database but the keys may be stored in a different location.

In preferred embodiments, LNK database security is achieved through encryption measures and by excluding third-party API access. In these embodiments, access to the LNK database is limited to developer accounts which may be secured using 2 factor authentication (2FA). In addition, the LNK database may feature rollback functionality, such as a 7-day rollback that restores the LNK database to a prior state in the event the system is compromised or damaged.

The blockchain is used to ensure database accuracy and immutability. If a change to the database is detected by a system that monitors database changes the contract ID is fetched and the metadata is read. If the smart contract ID returns a valid unique identifier, there is no error reported. If, on the other hand, contract metadata does not provide a match to the unique ID of the database listing an error warning is generated.

A computer implemented method is further disclosed which facilitates buying/selling of items and/or transfer of ownership in a secure and convenient manner using the blockchain, wherein a software application (LNK app) is configured to create a user profile when a user signs up for the LNK app. Upon signing up, a subwallet or digital closet is generated, and wallet keys (i.e., public and/or private keys) are held by the LNK app. Once the user is signed up and their subwallet (i.e., digital closet) is generated the user can select items by scanning their QR code, NFC chip, RFID, or other electronic transmitting tag. Upon scanning the item, the LNK app acquires basic information about the item, including for example, an image of the item, dimensions, material, colors, sizes, price, delivery options, rating, return policy, etc.

The LNK app then determines the status of the item, including: (1) whether the item is in a retail mode (i.e., the item was scanned in a retail environment); (2) whether the item is owned by another user (i.e., stored in their digital closet); or (3) whether the item is neither in retail mode nor owned by another user. If the item is owned by another user, the other user initiates a transfer of the scanned item. One will appreciate that initiating a transfer does not necessarily imply that the user will take ownership of the item, but rather means that a preliminary ownership transfer step has been taken. Once the transfer process is initiated, the item is ready to be added to the user's digital closet and the user decides whether to add the item to his or her closet by selecting a corresponding option in the LNK app.

Once the item is added to a user's closet the item transaction is processed by, for example, transferring an amount of cryptocurrency from the user's wallet that is equal to the price of the item and transferring ownership of the item to the user. The transaction is then recorded on the blockchain. Details of the recorded transaction may include:
TO (i.e., to whom the item was transferred)
FROM (i.e., from whom the item was transferred)
DESCRIPTION OF THE ITEM; and
PRECISE GEO LOCATION OF THE ITEM.

A person of ordinary skill in the art will appreciate that physical delivery may not be necessary since the transaction may only involve a transfer of ownership of the item from one owner to another owner (e.g., the user) without actual physical delivery. Once payment is made and ownership of the item is transferred to the user, the transaction is completed.

According to another computer implemented method the LNK app is further configured to create a retail brand profile when a retail brand signs up for the app and generates a brand specific portal. Specifically, upon sign up, the LNK app generates a brand specific portal for the retail brand. The LNK app may be further configured to invite employees of the retail brand to join the LNK app. According to this embodiment, a user can acquire an item from the retail brand by purchasing the item anywhere the brand is sold and may initiate a process of acquiring ownership by scanning the QR code/detecting the NFC chip associated with the item. Upon purchase, ownership rights are transferred or assigned to the user with or without physical transfer of the item. More specifically, the user can scan the item in a retail mode which indicates that the item is offered for sale at a retail store. The item is then ready to be added to the user's digital closet or subwallet. The user adds the item to their subwallet (i.e., digital closet) by selecting a corresponding option in the LNK app. Once the user adds the item to their subwallet, the item transaction is initiated and transfer of the item to the user is processed. That is, ownership rights to the item are transferred to the user in the LNK app by recording the transaction in the blockchain (i.e., distributed ledger). Details of the transaction may include:
TO (i.e., to whom the item was transferred)
FROM (i.e., from whom the item was transferred)
DESCRIPTION OF THE ITEM; and
PRECISE GEO LOCATION OF THE ITEM.
   The user's subwallet is updated to reflect this transfer of ownership when the transaction is recorded in the blockchain. At that point, the transaction is complete.

According to this method, the LNK app is further configured to allow the brand retailer to request a batch order. The batch order request entails creating tags (QR/NFC) for each item in the batch. Once the QR/NFC tags are created, the app logs HID into the system and the batch items are ready for release.

According to a preferred embodiment of this method, an ERC-1155 smart contract is created where ERC-1155 refers to a flexible Ethereum token standard that allows for the transfer of multiple types of tokens (e.g., fungible and non-fungible tokens) at once. The contract location is stored in the transaction database for the item and individual copies are created for each item. Subsequently, the LNK app mints an ERC-1155 token from the contract specific to the item and the token is assigned to a user's LNK wallet or subwallet. The token ID is stored in the closet item.

Once the QR code or NFC are created, the tags are applied to physical items. These items (i.e., the tagged batch items) are in retail mode by default and are ready to be sent to retail locations. A user can then purchase the item from the retail location as described above.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method for facilitating online purchases, the method comprising the steps of:
receiving an item request, wherein the item request comprises one or more of: a unique identifier, an item description, an item status, digital assets associated with the item, digital wallet information, previous transaction information, registration information, and brand information;
processing a request contained in the item request, wherein the request may be selected from the group comprising: adding a new item to a registry, retrieving information from the registry related to the item, providing information to a user related to the item; and
returning to the user a confirmation related to the request.

2. The computer implemented method of claim 1, wherein the unique identifier is selected from the group comprising: a QR code, a unique RFID, a unique NFC, a serial code, and a bar code.

3. The computer implemented method of claim 1, wherein the item status is selected from the group comprising: retail, secondary, and other.

4. The computer implemented method of claim 1, wherein the request involves processing a transaction on the item, where the item is already in the registry, further comprising the steps of:
confirming the type of request to be completed;
confirming user has the authority to complete the request; and
completing the request related to the item.

5. The computer implemented method of claim 1, wherein the request involves processing a transaction on the item, where the item is not already in the registry, further comprising the steps of:
determining if the request is a batch item add or a single item add;
parsing add item information from the item request; and
adding the item to the registry.

6. The computer implemented method of claim 1, further comprising the step of providing a stored digital asset from the registry to the user.

7. The computer implemented method of claim 1, further comprising the step of providing a digital closet to the user, wherein the item is displayed in the digital closet.

8. The computer implemented method of claim 1, further comprising the steps of:
transferring the ownership of the item to a second user; and
registering a transaction record related to the transfer of ownership of the item to the second user on a blockchain.

9. The computer implemented method of claim 8, further comprising the step of updating the item status based at least part on the transfer of ownership of the item to the second user.

10. A computer implemented system for facilitating online purchases, the system comprising:
one or more processors configured with machine operable code, configured to:
receive an item request, wherein the item request comprises one or more of: a unique identifier, an item description, an item status, digital assets associated with the item, digital wallet information, previous transaction information, registration information, and brand information;
process a request contained in the item request, wherein the request may be selected from the group comprising: adding a new item to a registry, retrieving information from the registry related to the item, providing information to a user related to the item; and
return to the user a confirmation related to the request.

11. The computer implemented system of claim 10, wherein the unique identifier is selected from the group comprising: a QR code, a unique RFID, a unique NFC, a serial code, and a bar code.

12. The computer implemented system claim 10, wherein the item status is selected from the group comprising: retail, secondary, and other.

13. The computer implemented system of claim 10, wherein the request involves processing a transaction on the item, where the item is already in the registry, wherein the one or more processors configured with machine operable code are further configured to:
confirm the type of request to be completed;
confirm user has the authority to complete the request; and
complete the request related to the item.

14. The computer implemented system of claim 10, wherein the request involves processing a transaction on the item, where the item is not already in the registry, wherein the one or more processors configured with machine operable code are further configured to:
determine if the request is a batch item add or a single item add;
parse add item information from the item request; and
add the item to the registry.

15. The computer implemented system of claim 10, wherein the one or more processors configured with machine operable code are further configured to provide a stored digital asset from the registry to the user.

16. The computer implemented system of claim 10, wherein the one or more processors configured with machine operable code are further configured to provide a digital closet to the user, wherein the item is displayed in the digital closet.

17. The computer implemented system of claim 10, wherein the one or more processors configured with machine operable code are further configured to:
transfer the ownership of the item to a second user; and
register a transaction record related to the transfer of ownership of the item to the second user on a blockchain.

18. The computer implemented system of claim 17, wherein the one or more processors configured with machine operable code are further configured to update the item status based at least part on the transfer of ownership of the item to the second user.
